(19) United States
(12) Patent Application Publication
(10) Pub. No.: US 2026/0228297 A1
(43) Pub. Date: Aug. 6, 2026

(54) SYSTEMS AND METHODS TO DETERMINE, COUNT, AND CLASSIFY ALL SOLUTIONS TO ANY NP PROBLEM

(71) Applicant: Turiyam Research LLC, Beaverton, OR (US)

(72) Inventor: Srinivas Balaji Bollepalli, Beaverton, OR (US)

(21) Appl. No.: 19/259,905

(22) Filed: Jul. 3, 2025

Related U.S. Application Data
(60) Provisional application No. 63/753,131, filed on Feb. 3, 2025.

(51) Int. Cl. G06F 17/10

(52) U.S. Cl. CPC G06F 17/10

(57) ABSTRACT

The methods described in this non-provisional patent filing are the result of a major mathematical breakthrough that resolves the P vs. NP problem. Techniques and systems for unconditionally solving the Subset Sum Problem in polynomial time are presented. The method not only provides a solution (when one exists) but also provides the total number of solutions (when more than one exists). Furthermore, all the solutions are classified into certain equivalence classes, and output in the form of a compact directed acyclic graph of polynomial size. Thus, not only can one find all solutions, but also understand the relations between them. As the Subset Sum Problem is an NP-complete problem, thousands of important problems to humanity from diverse areas of sciences, engineering, medicine, biology, technology, computation, mathematics, artificial intelligence, artificial general intelligence and more, that were previously considered intractable, can now be solved efficiently (in polynomial time instead of exponential time).

### CROSS-REFERENCE TO RELATED APPLICATION(S)

This application claims the benefit and priority to U.S. Application No. 63/753,131, filed Feb. 2, 2025, the entirety of which is hereby incorporated by reference. Where any document incorporated by reference and the present disclosure conflict, the present disclosure controls.

### BACKGROUND

### Technical Field

An NP problem may be any problem where a claimed solution can be verified in polynomial time. Many problems in diverse areas such as technology, engineering, medicine, biology, economics, Artificial Intelligence (AI) and more are known to be NP problems.

### Description of the Related Art

In many human endeavors as well as in scientific, medical, and technological pursuits, a solution to a relevant problem is found by searching through a space of possibilities. Furthermore, these problems are such that any potential solution can be checked quickly. Generally, if the process of checking or verifying a single potential solution itself takes an inordinate amount of time, such problems may not be of interest, or may not be considered, by scientists, researchers, etc.

According to the theory of computational complexity, problems that are easily verifiable, i.e., in polynomial (in the problem size) time, are considered NP problems. Many problems of human interest belong to this category. While problems in this class have varying levels of difficulty, depending on the problem, the difficulty of identifying a solution to the most important and useful problems increases exponentially as the space of possibilities increases.

As an example, a Boolean circuit may comprise a finite number of logic gates (AND, OR, NOT gates) connected in some arbitrary way, with a set of n inputs x=(x₁, x₂, . . . , xₙ) where each input is either 0 (FALSE) or 1 (TRUE), and a single output y which is also either 0 or 1. In this example, the “solution” to the circuit includes an identification of the inputs that will lead to a 1 at the output terminal. Such an example has 2ⁿ possible solutions (i.e., the number of possible solutions to consider increases exponentially based on the number of inputs to the circuit).

This example is known as the “Boolean Circuit Satisfiability Problem” and is of great importance in the design of integrated circuits (IC). The Boolean Circuit Satisfiability Problem is used to verify and test designs for circuits.

Computer scientists have discovered that any search problem where verification of a potential solution can be done easily can be reduced to a special “problem” referred to as an “NP-complete problem.” An NP-complete problem is also a search problem, but of the highest difficulty. Identifying a solution to an NP-complete search problem within polynomial time and without iteratively checking each potential combination has been a long-standing open problem (more than 50 years) in theoretical computer science and mathematics.

This question is known as the “P vs. NP problem.” If an NP-complete problem can be solved efficiently then all search problems where verification is easy can be solved efficiently. The Boolean Circuit Satisfiability Problem can be written as an algebraic Boolean formula known as the satisfiability problem (an “SAT problem”).

The SAT problem is a prototypical NP-complete problem, and is known for its versatility in capturing all the NP problems. In addition to the SAT problem, there are hundreds of other problems from diverse areas that are also NP-complete.

NP-complete problems are equivalent and can be transformed from one to another. Each NP-complete problem has the same order of difficulty. For example, “given a sequence of n positive integers (a₁, a₂, . . . , aₙ) and a target sum T, is there a subset that sums to T?” Such an example is referred to as the “Subset Sum Problem” which is an NP-complete problem. A “brute force” method to solve this problem (i.e., an iterative solution) also involves searching through 2ⁿ combinations.

As another example, proteins in the cells of a human body are made up of 20 different amino acids. A protein is a chain of these different amino acids, and their sequence determines the type of protein and its functionality. Given an amino acid sequence, what is the resulting three-dimensional protein structure? This is referred to as the Protein Folding Problem. The 3-dimensional structure determines the biological functionality of a given amino acid sequence. It is widely believed that the 3-dimensional conformation corresponds to the lowest free energy minimum of the given protein. Given a sequence of amino acids, the number of possible conformations in the 3-dimensional space is estimated to be on the order of 10140 or more.

In various models it has been shown that the Protein Folding Problem is NP-complete. The Protein Folding Problem is another example of an NP-complete problem with an exponential search space. In a healthy human cell, the three-dimensional protein structure folds in a specific way which is the native state and performs its functions correctly. However, in a diseased cell, such as a cancer cell, the protein folds incorrectly. Understanding this problem affects the understanding of how proteins function. Furthermore, solutions to this problem can help to design drugs that target the diseased proteins, and thereby find potential cures to many diseases.

Other problems in diverse areas such as technology, engineering, medicine, physical sciences, biology, economics, Artificial Intelligence (AI), etc., are also known to be NP-complete. The ability to solve these problems efficiently can lead to a positive transformation in all aspects of human life.

### BRIEF SUMMARY

The embodiments described herein relate determining, counting, identifying, and classifying solutions, if any, to an NP problem. In particular, the method may relate to any problem that can be reduced to a SAT or a SSP, and thus, any NP-complete problem. Various aspects of the present invention provide methods and systems to determine, identify, count, and classify all the solutions to any Subset Sum Problem (SSP). Since a SSP is NP-complete, it follows that any NP problem can be reduced to an instance of the SSP either directly or via a reduction to “3SAT” (i.e., a satisfiability problem with three literals) and then to a SSP. It is also possible to reduce a given NP problem to an instance of the SSP via reduction to some other NP-complete problem (instead of 3SAT) followed by a reduction to a SSP. Various reduction techniques may be used to reduce an NP-problem to a SSP.

Once an NP problem is reduced to a SSP, the embodiments disclosed herein are able to solve the NP problem in polynomial time. In some embodiments, the solution set obtained for the SSP can then be remapped to the original NP problem, such as by applying the reduction process in the reverse.

In some embodiments, the subset sum system converts a SSP problem to a two-dimensional problem by assigning a unique index to each of the given elements and converting it to a geometric problem. In some embodiments, the subset sum system identifies two or more initial curves that form non-decreasing paths from the origin to an extremal point corresponding to the sum of the elements of the SSP. The subset sum system may define one or more transformations that produce one or more new curves from an identified curve. The subset sum system may identify a graph structure, such as a Transformation Graph, that when applied to at least one of the two or more initial curves produce one or more possible curves that cover one or more points of the solution space. The possible curves disclose the hidden structure of the problem that is not evident in the one-dimensional setting. This structure allows the subset sum system to solve the NP problem without performing an exponential search for a solution to an NP problem.

In some embodiments, the subset sum system identifies one or more coordinates of a point in a curve. In such embodiments, the subset sum system may use local coordinates instead of global coordinates to represent a point in the reference frame of an edge (i.e., a “segment”) of the curve containing it. In some embodiments, the subset sum system constructs a search graph from the transformation graph. The search graph may be a layered directed acyclic graph where the nodes are edges and arcs are translations between edges. In such embodiments, a target value of the SSP becomes a point with local coordinates on an edge (i.e., a “root node”) of the initial curve. In some embodiments, the subset sum system finds “zero paths” in the search graph to solve the SSP problem.

In some embodiments, the subset sum system reduces the complexity of finding “zero paths” in the search graph by iteratively searching for zero paths where: in each iteration a refining step is performed to modify the graph and a filtering step is performed to remove parts of the graph that cannot support any zero paths. In such embodiments, the subset sum system produces a solution graph where every path is a zero path. In some embodiments, if the given instance of the SSP does not have a solution, then the solution graph is empty.

The subset sum system may count the number of solutions to the given instance. In some embodiments, the solution graph indicates a classification of one or more solutions to the SSP problem. In such embodiments, the subset sum system may identify information regarding the structure of the solutions indicated by the solution graph based on the classifications of the one or more solutions.

Additional aspects and applications will be apparent by the accompanying figures and a detailed description of the method given below.

### BRIEF DESCRIPTION OF THE SEVERAL VIEWS OF THE DRAWINGS

FIG. 1 is a block diagram of various environments in which the subset sum system is able to operate, according to various embodiments described herein.

FIG. 2 is a flow diagram of a sample process to solve a subset sum problem, according to various embodiments described herein.

FIG. 3 is a flow diagram of a sample process to generate a solution graph for a subset sum problem, according to various embodiments described herein.

FIG. 4 is a circuit diagram of a sample circuit for which the subset sum system is able to be used, according to various embodiments described herein.

FIG. 5 is a table diagram of a sample table generated as part of solving a subset sum problem for the sample circuit described above in connection with FIG. 4, according to various embodiments described herein.

FIG. 6 is a graph diagram of a first curve generated as part of solving the subset sum problem for the sample circuit described above in connection with FIG. 4, according to various embodiments described herein.

FIG. 7 is a graph diagram of a second curve generated as part of solving the subset sum problem for the sample circuit described above in connection with FIG. 4, according to various embodiments described herein.

FIG. 8 is a graph diagram of a third curve generated as part of solving the subset sum problem for the sample circuit described above in connection with FIG. 4, according to various embodiments described herein.

FIG. 9 is a graph diagram of a fourth curve generated as part of solving the subset sum problem for the sample circuit described above in connection with FIG. 4, according to various embodiments described herein.

FIG. 10 is a block diagram of a sample transformation graph generated as part of solving the subset sum problem for the sample circuit described above in connection with FIG. 4, according to various embodiments described herein.

FIG. 11 is a diagram of a sample solution graph generated as part of solving the subset sum problem for the sample circuit described above in connection with FIG. 4, according to various embodiments described herein.

FIG. 12 is a sample block diagram showing some of the components typically incorporated in at least some of the computer systems and other devices on which the embodiments of the system described herein may operate.

### DETAILED DESCRIPTION

Scientific research, scheduling, routing, and other fields all deal with the solution of decision problems that involve many possible solutions. For example, let “D” denote an arbitrary decision problem of size “n” with a Yes/No answer. Let “w” be a claimed witness to the decision problem D with a “Yes” answer. If the verification that w is a solution to D can be done easily, i.e., in time less than “n°” where “c” is a positive constant, then we say that problem D can be verified in polynomial time. Thus, problem D is an NP problem (i.e., a problem within the class “NP”). The class NP is the set of all decision problems whose verification can be performed in polynomial time.

As the size of the decision problem grows, the difficulty of finding solutions grows exponentially. However, researchers in many different fields have been unable to find a method of solving any NP problem quickly. As a result, researchers must individually verify each potential solution in order to solve an NP problem. Because the difficulty and time needed to solve an NP problem increases exponentially as the size of the decision problem grows, the number of potential solutions for the vast majority of NP problems are too numerous for researchers to consider, even with the aid of computing devices.

An NP problem can be reduced (i.e., “transformed”) into a Satisfiability Problem (SAT) with variables and clauses that correspond to the variables and constraints of the NP problem. The SAT is an “NP-complete problem,” that is, a SAT problem is at least as difficult to solve as an NP problem. If a SAT problem can be solved via a polynomial time algorithm, then a corresponding NP problem can also be solved in polynomial time.

Other NP problems also have the same order of difficulty as that of SAT problems. Such NP problems can be converted into a SAT problem in polynomial time. An example of one such problem is the Subset Sum Problem (SSP). Other examples include the Boolean Circuit Satisfiability Problem, the Travelling Salesman Problem, the Clique problem, etc.

Furthermore, a literal may represent a Boolean variable xᵢ or its logical negation −(xᵢ) taking on values of one or zero, which represent TRUE or FALSE. A clause may represent a disjunction (i.e., logical OR) of literals. The Satisfiability Problem (SAT) may be represented as a conjunction (logical AND) of clauses. While a clause in a SAT problem can contain any number of literals, it can be converted to an equivalent formula where every clause has exactly three literals. Such a problem may be referred to as a “3SAT problem.” A 3SAT Problem consisting of 1 literal and k clauses can be converted to a SSP of size 2(l+k) with numbers whose size is less than l+k digits. Additionally, if there are Nₛ solutions to the given 3SAT, then there will be Nₛ solutions to the SSP as well, where Nₛ∈[0,2ⁿ].

The present disclosure incorporates by reference herein in their entirety: Cook, S. A., “The complexity of theorem-proving procedures”, Proc. 3rd Ann. ACM Symp. on Theory of Computing, Association for Computing Machinery, New York, pp 151-158, 1971; Cook, S., “The P versus NP problem (Clay Math Institute official problem description)”, “\url{http://www.claymath.org/sites/default/files/pvsnp.pdf}”, 2000; Karp, M. R., “Reducibility among combinatorial problems”, R. E. Miller and J. W. Thatcher (eds.), Complexity of Computer Computations, Plenum Press, New York, pp 85-103, 1972; Berger, B. and Leighton T., “Protein Folding in the Hydrophobic-Hydrophic (HP) Model is NP-complete”, RECOMB '98: proceedings of the second annual international conference on Computational molecular biology, pp 30-39, 1998; Crescenzi, P., Goldman, D., Papadimitriou, C., Piccolboni, A., and Yannakakis, M., “On the Complexity of Protein Folding (Extended Abstract)”, Symposium on the Theory of Computing 1998, Dallas, Texas, pp 597-603, 1998; Gary, R. M. and Johnson, S. D., “Computers and Intractability”, W. H. Freeman and Company, New York, 1979; Moore, C. and Mertens, S., “The Nature of Computation”, Oxford University Press, Great Clarendon Street, Oxford OX2 6DP, 2015; Widgerson, A., “Mathematics and Computation, A Theory Revolutionizing Technology and Science”, Princeton University Press, 41 William Street, Princeton, New Jersey 08540, 2019; Sipser, M., “The history and status of the P versus NP question”, In Proc. 24th Symp. on Theory of Computing, pp 603-618, 1992; and Arora, S. and Barak, B., “Computational Complexity, A Modern Approach”, Cambridge University Press, 32 Avenue of Americas, New York, NY 10013-2473, 2009. Where any document incorporated by reference and the present disclosure conflict, the present disclosure controls.

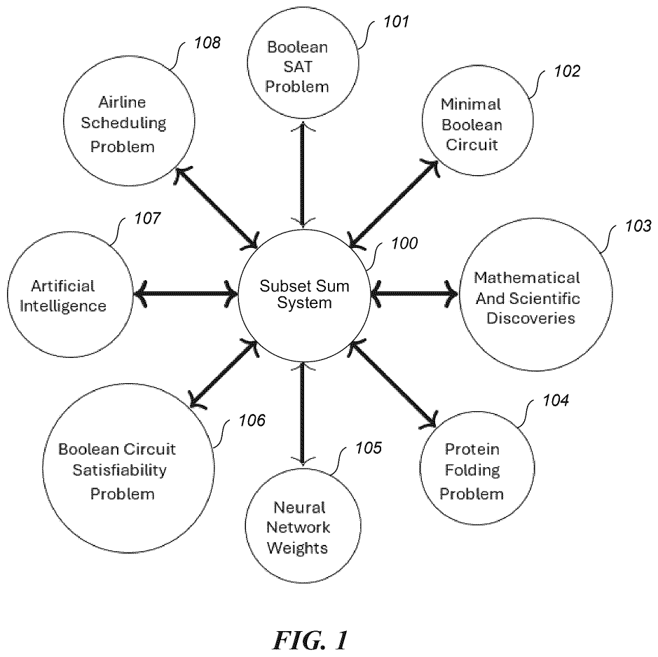

FIG. 1 is a block diagram of various environments in which a subset sum system 100 is able to operate, according to various embodiments described herein. The various technological environments in which the subset sum system 100 may operate include: environments involving circuits, such as the Boolea SAT problem 101, minimal Boolean circuit problem 102, Boolean circuit satisfiability problem 106, etc.; scientific and mathematical fields, such as fields for scientific and/or mathematical discoveries 103, the protein folding problem 104, etc.; air traffic, such as the airline scheduling problem 108, other air traffic problems, etc.; machine learning, such as adjusting or determining neural network weights 105, configuring machine learning and/or artificial intelligence models 107, etc.; or some combination thereof. Although this disclosure describes how the subset sum system 100 may be used to verify the viability of a Boolean circuit by solving the Boolean circuit satisfiability problem for an example Boolean circuit, one of ordinary skill in the art would recognize that the processes used by the subset sum system 100 can be used to solve all NP problems and cause systems associated with those problems to be improved.

In the Boolean Circuit Satisfiability Problem, if n=100 (i.e., the number of literals is one hundred), then the number of possible solutions to the problem exceeds a one followed by thirty zeros. No computer, or even a large computing system, is able to search through this space of possibilities one by one- and doing so would take an inordinate amount of time. Currently, there are no efficient techniques available to solve such a problem exactly. While sets of heuristic techniques to solve the problem exist, these techniques (1) cannot always find a solution even when one is guaranteed, and (2) cannot certify that there is no solution when one cannot be found by using the technique.

These deficiencies manifest in many deleterious ways. For example, in a circuit design problem, one may end up with a much larger circuit instead of an optimal smaller one, because the existing techniques failed to find the solution. This also leads to poor circuit designs that necessitate excess power consumption, sub-optimal use of materials, and increased manufacturing expenditure. As all the various NP-complete problems are widely believed to be intractable, scientists and engineers must use inferior approximate solutions, accepting the significant economic loss that accompanies the poor solutions. In some areas such as drug discovery the loss involves far more than economic considerations.

In recognition of these properties of NP problems, SAT problems, and SSPs, the inventor has conceived and reduced to practice a system, the “subset sum system 100,” that is able to solve any NP-complete problem. The subset sum system 100 may use the solution to an NP-complete problem to perform tasks within the technological domain for which the NP problem is concerned.

By performing in some or all of the ways described below, the system is able to solve NP-complete problems, such as the Boolean circuit satisfiability problem, in a way that identifies all of the solutions, if any, to the problem. Thus, the system is able to solve all NP problems that computing systems are unable to solve iteratively (i.e., by searching through the space of every possible solution). Also, the system improves the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with lesser latency, and/or preserving more of the conserved resources for use in performing other tasks. For example, by operating in the manner described below to solve an NP problem, the subset sum system 100 is able to solve NP problems more quickly and more accurately than other computer devices that use conventional methods to identify solutions to NP problems. Additionally, with respect to at least the Boolean circuit satisfiability problem, the subset sum system is able to more accurately verify circuit designs and improve the design of such circuits.

Further, for at least some of the domains and scenarios discussed herein, the processes described herein as being performed automatically by a computing system cannot practically be performed in the human mind, for reasons that include that the starting data, intermediate state(s), and ending data are too voluminous and/or poorly organized for human access and processing, and/or are a form not perceivable and/or expressible by the human mind; the involved data manipulation operations and/or subprocesses are too complex, and/or too different from typical human mental operations; required response times are too short to be satisfied by human performance; etc.

Although this disclosure describes how the subset sum system 100 may be used to verify the viability of a Boolean circuit by solving the Boolean circuit satisfiability problem for an example Boolean circuit, one of ordinary skill in the art would recognize that the processes used by the subset sum system 100 can be used to solve all NP problems and cause systems associated with those problems to be improved. As discussed above, any technological problem that is considered to be an NP problem could be solved via the subset sum system. For example, the invention described here can be used as a SAT solver since there is a direct reduction from SAT to the Subset Sum Problem. Thus, the invention described here must be accorded the widest scope consistent with the ideas and methods disclosed.

In the following description, for a positive number “n,” the set \{1, 2, . . . ,n\} is referred to as “[n].” Thus, the term j∈[n] means that j is a positive integer between 1 and n. Additionally, in this description, the given sequence of numbers of a SSP are represented as a=(a₁, a₂, . . . , aₙ) and the given target number is denoted by T. Furthermore, in this description, it is assumed that all the elements aᵢ∈a can be represented in binary using at most “m” digits.

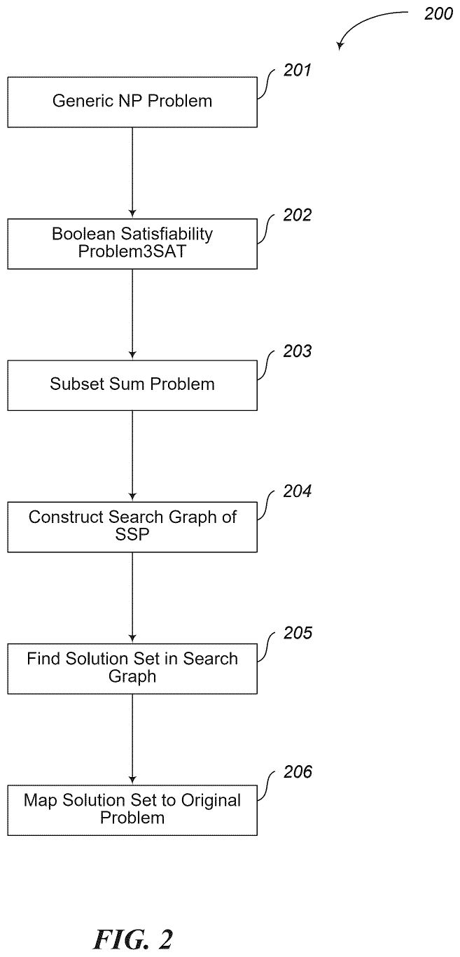

Those skilled in the art will appreciate that the acts shown in FIG. 2 and in each of the flow diagrams discussed below may be altered in a variety of ways. For example, the order of the acts may be rearranged; some acts may be performed in parallel; shown acts may be omitted, or other acts may be included; a shown act may be divided into subacts, or multiple shown acts may be combined into a single act; etc.

FIG. 2 is a flow diagram of a sample process 200 to solve a subset sum problem, according to various embodiments described herein. In some embodiments, a subset sum system, such as the subset sum system 100 described above in connection with FIG. 1, performs one or more aspects of the process 200.

The process 200 begins at act 201, where the subset sum system receives an indication of an NP problem. In some embodiments, the subset sum system identifies the NP problem based on a technological environment associated with the NP problem.

At act 202, the subset sum system converts the NP problem into a satisfiability problem. In the example described below with respect to the Boolean circuit satisfiability problem, the NP problem is converted into a Boolea SATisfiability problem, such as 3SAT. Although the examples provided in this disclosure describe the use of the subset sum system with respect to a 3SAT, one of ordinary skill in the art would recognize that other satisfiability problems could be used by the subset sum system, and the NP problem could be converted into other types of satisfiability problems, such as a Boolean circuit satisfiability problem. In some embodiments, converting an NP problem into a Boolean circuit satisfiability problem includes generating a Boolean circuit that represents the NP problem.

At act 203, the subset sum system generates a subset sum problem representing the original NP problem based on the satisfiability problem.

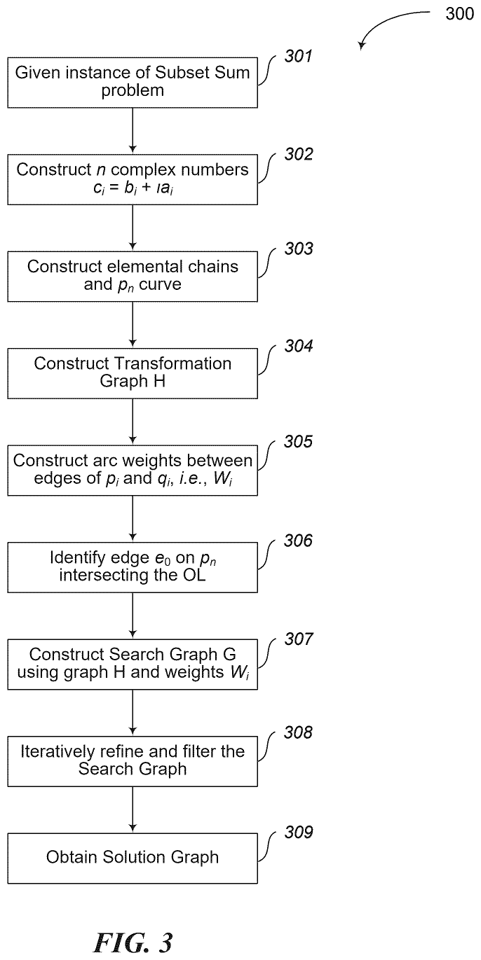

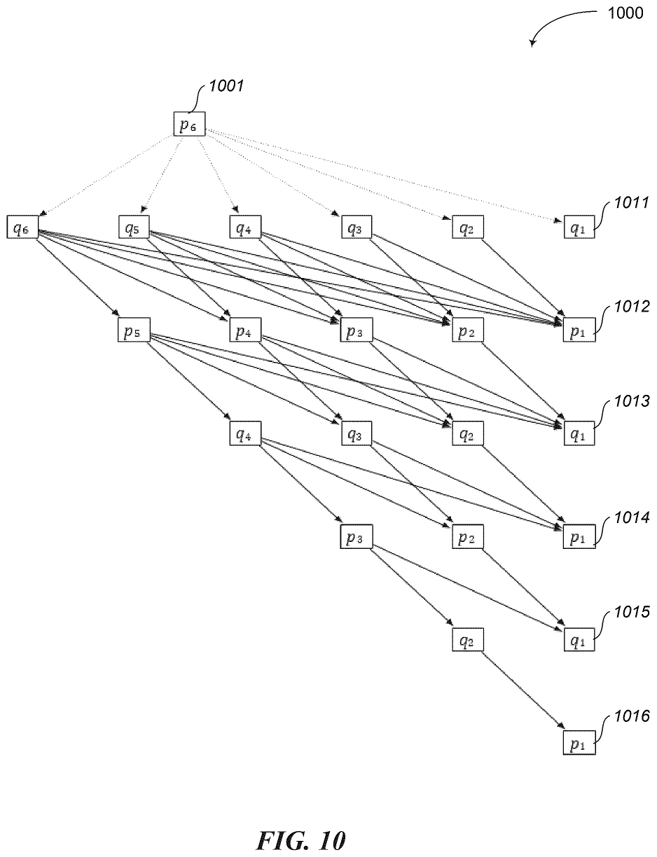

At act 204, the subset sum system constructs a search graph for the subset sum problem, such as by using the process 300, described below in connection with FIG. 3. An example of such a search graph is described below in connection with FIG. 10.

At act 205, the subset sum system identifies the solution set for the subset sum problem based on the search graph. In some embodiments, the subset sum system identifies the solution set for the subset sum problem by identifying one or more “zero paths” in the search graph with a start value y₀∈e₀.

One of ordinary skill in the art would recognize that a “brute force” search for the zero paths in such a search graph would be highly complex, and the complexity would increase with the number of inputs and outputs of the original NP problem. Thus, a brute force search, whether performed via a computing system or one or more humans with the aid of pen and paper, would consume too many computing and human resources to be practical. Accordingly, to identify the zero paths, the subset sum system employs an iterative algorithm that identifies the zero paths. In some embodiments, the iterative algorithm refines and filters the nodes of the search graph at each step of the algorithm. In some embodiments, the algorithm comprises marking all nodes of the search graph as TRUE, which indicates that all these nodes are potential candidates that can have an incoming zero path. In some embodiments, the algorithm comprises determining whether a particular node cannot have a zero path going through its lower vertex, and marking the particular node FALSE. In some embodiments, if y₀≠0 then the subset sum system identifies e₀ (i.e., a root node) as FALSE since there is not a zero path into e₀. In some embodiments, the algorithm comprises defining a “dummy node” labeled e_{∞} that connects to all the TRUE nodes by zero weight arcs.

In some embodiments, to refine the nodes of the search graph, the subset sum system divides an edge of the search graph into two halves (i.e., smaller edges). In such embodiments, an edge eᵢ is divided into two smaller edges

$${e}_{i}^{′} and {e}_{i}^{″} ,$$

the lower half and the upper half, respectively. Since the lower vertex of

$${e}_{i}^{″}$$

is not a point in the solution space, the subset sum system marks this node as FALSE. In some embodiments, if the y length of the given edge is less than or equal to one, the subset sum system does not divide the edge. As a result of refining the edges, a pair of interacting edges produce four refined edges, which results in at most three interacting edge pairs. Furthermore, by refining the edges, the subset sum system reduces the arc weights and aligns the edges of the search graph. In some embodiments, as a result of refining the edges, the resulting graph has at most twice the number of nodes and at most thrice the number of arcs as that of the unrefined graph. In some such embodiments, the root node is split into two parts, of which one part that contains the initial point (x₀, y₀) is modified to reflect the reference frame (either lower half or upper half) that contains it. The subset sum system may perform the refining step in linear time in the size of the graph.

In some embodiments, the subset sum system filters nodes by removing nodes and arcs that cannot support zero paths. In some embodiments, the subset sum system computes the shortest and longest paths to all nodes from e₀ based on a modification of a standard single source shortest paths algorithm. For example, the subset sum system may use the method described in Dasgupta, S., Papadimitriou, C. H., and Vazirani, U. V., “Algorithms”, Addison-Wesley, Reading Massachusetts, 2006, to compute the shortest and longest paths to the nodes from e₀. Dasgupta, S., Papadimitriou, C. H., and Vazirani, U. V., “Algorithms”, Addison-Wesley, Reading Massachusetts, 2006, is incorporated by reference herein in its entirety. Where any document incorporated by reference conflicts with the present disclosure, the present disclosure controls. In some embodiments, the subset sum system computes the reverse shortest and longest paths from e_{∞} with y_{∞}=0. If the longest path from e₀ or e_{∞} to a node is negative, the subset sum system removes the node. If the shortest path from e₀ or e_{∞} is greater than the edge length, the subset sum system removes the node. These two cases correspond to edges that do not intersect the orbital line (the “OL”), such as the orbital line described below with respect to process 300. If the shortest path from e₀ to a node is positive and valid, then the subset sum system marks the node as FALSE, since there can be no zero path to this node. If the interval consisting of the shortest and longest paths from e₀ to a selected node does not intersect with that from e_{∞} to the selected node, the selected node cannot support zero paths and may be removed by the subset sum system. In some embodiments, the subset sum system performs the filtering step at most “n” times. The shortest and longest paths may change when one or more intermediate nodes and arcs are removed by the subset sum system. In some embodiments, the subset sum system filters one or more nodes, one or more arcs of the graph, or some combination thereof, based on reachability from e₀ and e_{∞}. The reachability from e₀ and e_{∞} refers to whether a connected path from either of the node e₀ or the node e_{∞} exists. The complexity of finding the shortest and longest paths in a directed acyclic graph is linear in the size of the graph. Thus, the subset sum system may perform the filtering step in polynomial time.

In some embodiments, the subset sum system executes the algorithm to search for zero paths for “m” steps, where “m” is the number of bits required to represent “aₙ.” In some embodiments, the subset sum system performs the refining described above, filtering described above, or some combination thereof, at each step. At the end of m iterations, all edge lengths will be “unity” or zero, and all arc lengths will be zero. If there are no TRUE nodes in the graph, the subset sum system determines that there are no solutions to the SSP. If there are one or more TRUE nodes in the graph, the subset sum system determines that there are solutions to the SSP. In some embodiments, every leaf node in the search graph is a TRUE node.

If the subset sum system determines that there is at least one solution to the SSP (i.e., final graph Gₘ (the “Solution Graph”) is not empty), the subset sum system determines how many solutions there are to the SSP. In some embodiments, to determine how many solutions there are to the SSP, the subset sum system associates a “counter” with each node and sets the value of the counter at the root node to 1. In such embodiments, the subset sum system may update the counter associated with each node to equal the sum of the counters associated with the node's immediate parent nodes. The subset sum system may determine that the number of solutions to the SSP is the value of the counter associated with node “e_{∞}.”

It can be proven that the process performed by the subset sum system to determine the number of solutions to the SSP can be accomplished in polynomial time and space. In particular, the overall time and space complexity in the worst case can be proven to be O(n¹³), but for many instances, the complexity is significantly less. Furthermore, the process performed by the subset sum system results in a natural classification of the solutions based on the nodes (i.e., “equivalence classes”) where the solution paths end.

If a given NP problem, when reduced to a SSP, results in multiple solutions, the subset sum system may select the “least expensive” solution, for example, by choosing the solution closest to the root level of the solution graph. One of ordinary skill in the art would recognize that many different metrics to choose the best solution may be used based on the given NP problem. There are situations where not all solutions may be equal as they have to satisfy additional constraints. In such cases the classification of solutions by the process performed by the SSP allows the subset sum system to select a solution that satisfies the additional constraints. Accordingly, the process performed by the subset sum system not only improves previous systems and processes by identifying all of the solutions to a SSP, it also classifies the identified solutions such that each of the solutions can be assessed for their suitability for application in a real-life system (i.e., in the design of circuits, in air traffic control systems, to determine the function of proteins, etc.).

At act 206, the subset sum system maps the identified solution set to the original NP problem, such as by reversing the process to reduce the NP problem into the SSP performed in acts 203 and 202. After act 206, the process 200 ends.

FIG. 3 is a flow diagram of a sample process 300 to generate a solution graph for a subset sum problem, according to various embodiments described herein.

First, at act 301, the subset sum system receives an instance of a subset sum problem. In some embodiments, the instance of a subset sum problem is received by using at least a portion of the process 200 described above.

At act 302, the subset sum system sorts the elements of a (i.e., the received subset sum problem) in increasing order. It can be assumed without the loss of generality that a₁≤a₂≤ . . . ≤aₙ. The subset sum system constructs n complex numbers cᵢ=bᵢ+ιaᵢ where bᵢ=2ⁱ⁻¹ for all i∈[n] and ι=√(−1). The subset sum system also defines the sums Bᵢ=b₁+ . . . +bᵢ and Aᵢ=a₁+ . . . +aᵢ for all i∈[n].

The subset sum system constructs n other complex numbers, referred to herein as “differences.” The differences may be defined by dᵢ=cᵢ−cᵢ₋₁ for all i∈[n] with the convention that c₀=0. It follows that cᵢ=d₁+d₂+ . . . +dᵢ for all i∈[n]. The sequence of all differences are denoted by D, so that D=(d₁, d₂, . . . , dₙ). The complex numbers dᵢ may be referred to as “links,” and each link can be interpreted as a line segment joining point (0,0) with the point (bᵢ−bᵢ₋₁, aᵢ−aᵢ₋₁) in the Cartesian plane.

A chain may be defined as a concatenation of links, where the operation of concatenation is denoted by ⊕. A chain may be denoted by a ∂ symbol preceding an alphabetical character. For example, the chain ∂L=d₁⊕d₂ is a chain composed of concatenating two links d₁ and d₂. The elements of D serve as building blocks to form chains.

At act 303, the subset sum system defines one or more elemental chains, such as ∂cᵢ=d₁⊕d₂⊕ . . . ⊕dᵢ and ∂ [symbol] =dᵢ⊕dᵢ₋₁ . . . ⊕d₁, for all i∈[n]. The chain ι [symbol] is the reverse of the chain ∂cᵢ. The elemental chains correspond to one or more given numbers of the Subset Sum Problem.

The subset sum system may construct a “family” of longer chains (i.e., “complementary chains”) denoted by ∂pᵢ and ∂qᵢ for all i∈[n]. The complementary changes may comprise one or more elemental chains as follows:

$$\partial {p}_{i} = \partial \text{?} ⊕ … ⊕ \partial \hat{{c}_{ι}} and \partial {q}_{i} = \partial {c}_{i} ⊕ … ⊕ \partial {c}_{1}$$

where i∈[n]. In terms of building blocks, these are
∂pᵢ= [symbol] ⊕ [symbol] ⊕ . . . ⊕ [symbol] and
∂qᵢ= [symbol] ⊕ . . . ⊕ [symbol] ⊕ [symbol] where the elemental chains are boxed. The chain ∂pᵢ may be a reverse of the chain ∂qᵢ. In some embodiments, by constructing the chains in this manner, the subset sum system constructs n pairs of complementary chains. The chains ∂pᵢ and ∂qᵢ may have i elementary chains each and a total of

$$\frac{i ( i + 1 )}{2}$$

building block links.

The subset sum system may perform a “σ operation” on chains that gives a cumulative sum of all links up to the current link in the given chain, such as:

$$\sum ( \partial {p}_{i} ) = ( 0 , {d}_{1} , {d}_{1} + {d}_{2} , … , i {d}_{1} + ( i - 1 ) {d}_{2} + … + 2 {d}_{i - 1} + {d}_{i} )$$

The last element in the above sequence may be recognized as Bᵢ+ιAᵢ, or as the point (Bᵢ, Aᵢ). Thus, σ(∂pᵢ) is sequence of

$$1 + \frac{i ( i + 1 )}{2}$$

points, which is denoted by pᵢ. Similarly, the points of σ(∂qᵢ) are denoted by qᵢ. These sequences of points pᵢ and qᵢ have the same start point of (0,0) and the same end point of (Bᵢ, Aᵢ). The points of pᵢ and qᵢ may be referred to as vertex points. By connecting adjacent vertex points by a straight line, the sequences pᵢ and qᵢ can be viewed as piecewise-linear curves pᵢ(t) and qᵢ(t) respectively.

The sequences pᵢ and qᵢ are called complementary since the x coordinates of points in pᵢ are the complements of those of qᵢ in binary. Furthermore, they satisfy a Point Reflection Symmetry about the center point

$$( \frac{{B}_{i}}{2} , \frac{{A}_{i}}{2} ) .$$

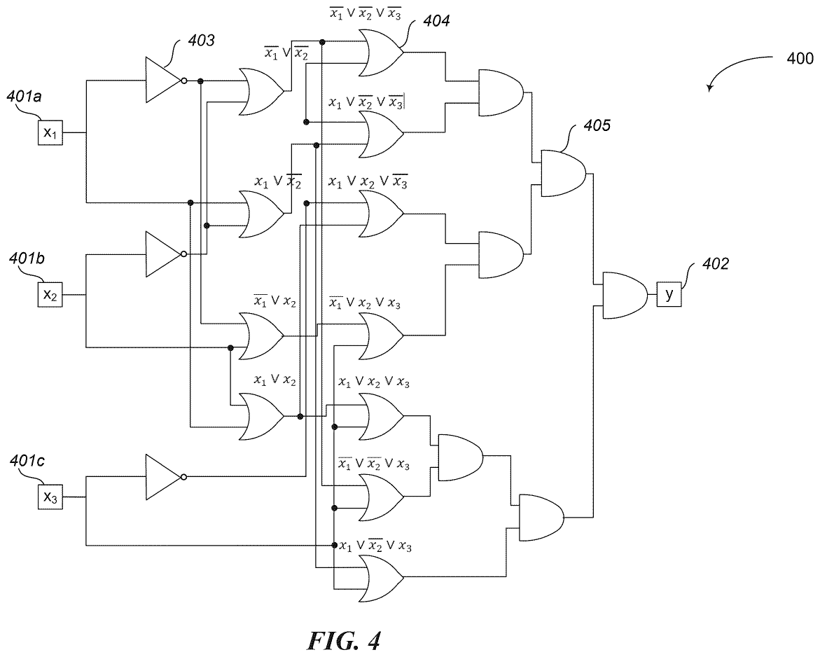

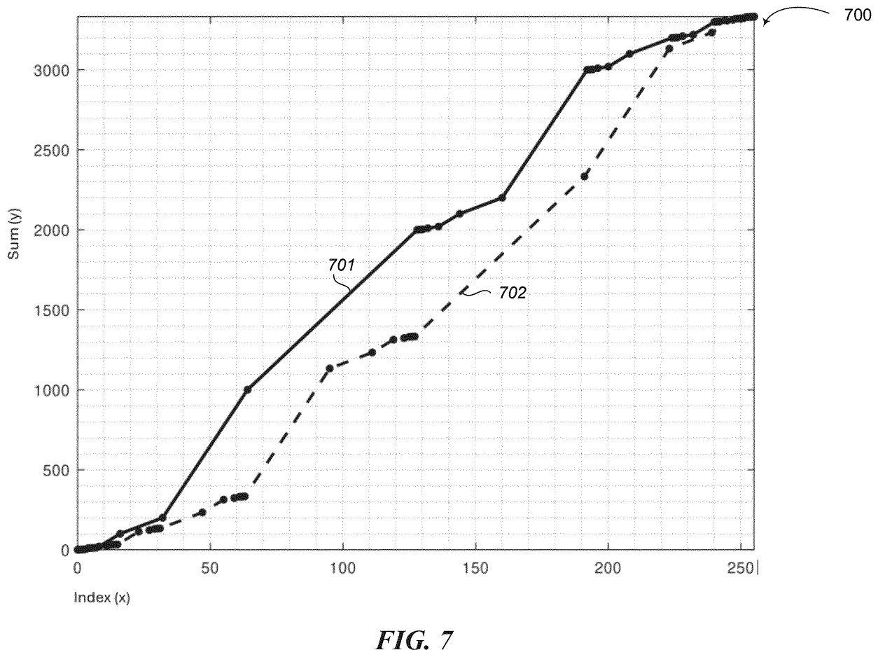

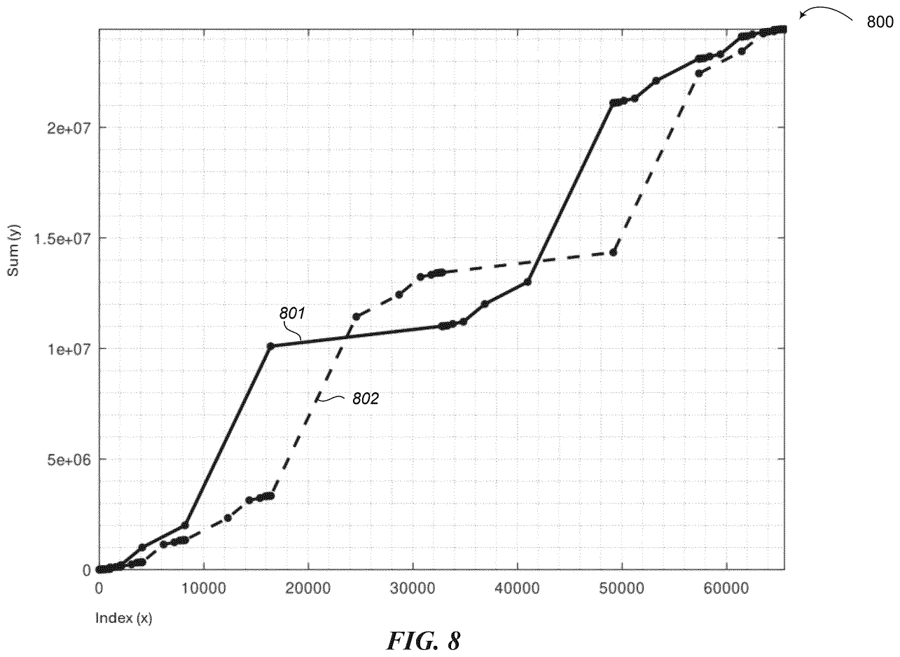

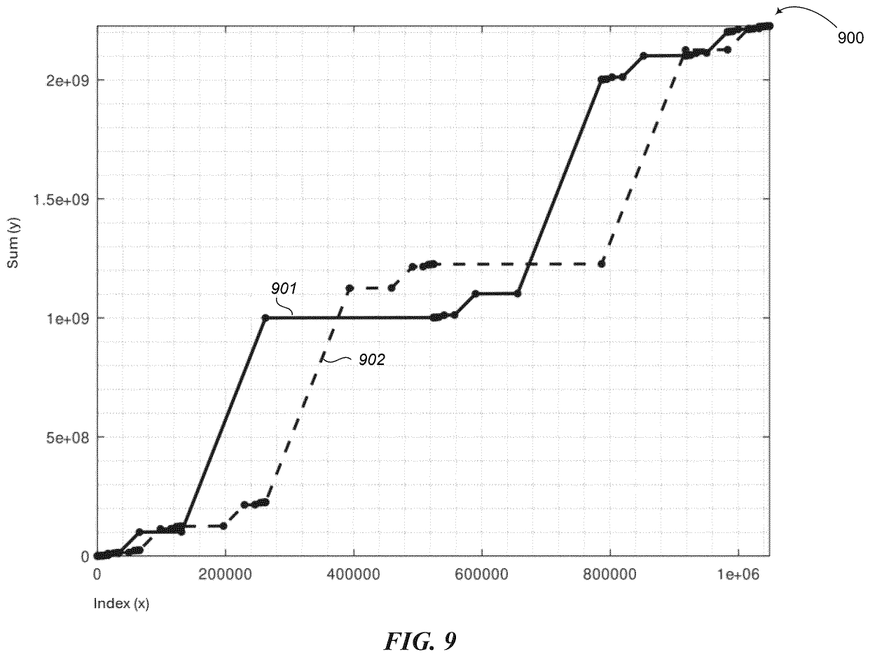

For the Sunset Sum Problem associated with the Boolean Circuit Satisfiability Problem, described below in connection with FIGS. 4-11, FIG. 6 shows the complementary curves p₄ and q₄, FIG. 7 shows p₈ and q₈ curves, FIG. 8 shows curves p₁₆ and q₁₆ curves, and FIG. 9 shows curves p₂₀ and q₂₀ curves. Since the curve is simply a cumulative sum of links, curves and chains are equivalent objects.

The segments connecting adjacent points of each curve pᵢ (or qᵢ) are referred to herein as “edges.” An edge may be a translated link. The curves pᵢ and qᵢ each nave

$$\frac{i ( i + 1 )}{2}$$

edges. If eᵣ is an edge of pᵢ, where

$$r ∈ [ \frac{i ( i + 1 )}{2} ] ,$$

there is a lower end point

$${z}_{r}^{-} = ( {x}_{r}^{-} , {y}_{r}^{-} )$$

associated with the edge and a higher end point

$${z}_{r}^{+} = ( {x}_{r}^{+} , {y}_{r}^{+} )$$

associated with the edge. Based on these definitions,

$${z}_{r}^{+} - {z}_{r}^{-} = {d}_{k}$$

for some k∈[n].

In some embodiments, if eᵣ is an edge of curve pᵢ for a given i∈[n], and if eₛ is an edge of the curve qᵢ, the subset sum system may determine that edges eᵣ and eₛ interact if and only if

$$min ( {y}_{r}^{+} , {y}_{s}^{+} ) \geq min ( {y}_{r}^{-} , {y}_{s}^{-} ) .$$

In some embodiments, the subset sum system may determine that the edges eᵣ and eₛ interact if and only if the y-projections of eᵣ and eₛ have a non-empty intersection. In some embodiments, the subset sum system may define an interaction weight of two interacting edges eᵣ∈pᵢ and

$${e}_{s} ∈ {q}_{i} by {w}_{r s} = {z}_{s}^{-} - {z}_{r}^{-} .$$

In such embodiments, wᵣₛ the translation of lower vertex of eₛ from the lower vertex of eᵣ in the Cartesian plane.

In some embodiments, the subset sum system may determine, based on a given i∈[n], that Wᵢ:={wᵣₛ:eᵣ∈pᵢ, eₛ∈qᵢ and eᵣ interacts with eₛ} is a set of all interaction weights between the interacting edges of curves pᵢ and qᵢ. In such embodiments, if |Wᵢ| denotes the size of the set Wᵢ, then the subset sum system determines that

$$\vert {W}_{i} \vert \leq \frac{{i}^{3} + 6 {i}^{2} - i}{6}$$

for all i∈[n]. In such embodiments, Wᵢ represents the translations from the lower vertices of edges of pᵢ to the lower vertices of edges of qᵢ. The set of reverse translations, i.e., from edges of qᵢ to edges of pᵢ may be referred to as −Wᵢ.

The subset sum system may compute all the n sets W₁, W₂, . . . , Wₙ corresponding to the n pairs of complementary curves for a given instance of a SSP. The subset sum system may use these special and non-obvious sets to perform at least some of the methods, processes, etc., described in this filing.

Given a chain, the subset sum system may define the active region as the longest sequence of elemental chains such that it corresponds to a ∂pₖ or a ∂qₖ for some k∈[n]. For example, if the given chain is ∂ψ defined by

$$\partial ψ = \partial {c}_{5} ⊕ \partial {c}_{3} ⊕ \partial {c}_{2} ⊕ \partial {c}_{1} ⊕ \text{?} ⊕ \partial \text{?} ⊕ \partial \text{?}$$

then the active region has a length of three, since ∂c₃⊕∂c₂⊕∂c₁ is the longest sequence that corresponds to ∂q₃. The subset sum system may use a τ operation, which operates on the active region of a given chain to produce another chain. In such an embodiment, if ∂pᵢ is a given chain for some i∈[n], then, for a given positive integer j≤i, the τⱼ operation may be defined as follows:

$${τ}_{j} ( \partial {p}_{i} ) = {τ}_{j} ( \text{?} ⊕ \text{?} ⊕ … ⊕ \text{?} ) = \text{?} ⊕ \text{?} , ⊕ … ⊕ \text{?}$$

Thus, the subset sum system reverses the order of the first j elemental chains based on the τⱼ transformation on ∂pᵢ, and reverses the links of the reversed elemental chains. As a result, the first j elemental chains correspond to the curve qⱼ. Similarly, the subset sum system may perform the τⱼ operation on the ∂qᵢ chain where j≤i as follows:

$${τ}_{j} ( \partial {q}_{i} ) = {τ}_{j} ( \partial {c}_{i} ⊕ … ⊕ \partial {c}_{j + 1} ⊕ \text{?} ) = \partial {c}_{i} ⊕ … ⊕ \partial {c}_{j + 1} ⊕ \text{?}$$

Thus, subset sum system reverses the order of the last j elemental chains based on the τⱼ transformation on ∂qᵢ, and reverses the links of the reversed elemental chains. As a result, the last j elemental chains now correspond to the curve pⱼ. Thus, the subset sum system may use the τ operation to transform part of a p curve to a q curve and vice versa. In some embodiments, the length of the active region is non-increasing as the subset sum system applies τ transforms. In some embodiments, the subset sum system can only apply a τⱼ transformation on a chain if and only if the active region length is greater than or equal to j. In such embodiments, even though the length of the active region is reduced by a τ transformation, the length of the chain remains the same.

At act 304, the subset sum system constructs a transformation graph. In such embodiments, the subset sum system may use the ∂pₙ chain which has an active region length of n. In such embodiments, the subset sum system admits all the transformations τ₁, τ₂, . . . , τₙ. The subset sum system may apply the transformations τ₁, τ₂, . . . , τₙ in parallel on ∂pₙ. As a result, the subset sum system obtains n new chains where the modified portions correspond to q type curves. The subset sum system may, for each new chain ∂qᵢ, apply the τⱼ operation enforcing j<i, and may continue this process until the active region of chains is 1. This process may be represented by a graph structure such as the transformation graph 1000, described below in connection with FIG. 10. In such a transformation graph, each layer may consist of either p type or q type chains but not both, and the chains may alternate. In this transformation graph, the active regions of chains are referred to as “nodes,” and τ transformations are referred to as “arcs.” The transformation graph may be referred to herein as an “H graph.” Since chains and curves are equivalent objects, the nodes of the graph may be labeled as curves. This transformation graph may have n+1 levels, and a total of

$$\frac{n ( n + 1 )}{2}$$

nodes excluding the root node pₙ. An example of the structure of this graph where n=6 is shown in FIG. 10.

A path in the H graph may be a sequence of nodes connected by arcs originating at pₙ. For a selected node in level i and indexed by j, it can be shown that the number of paths to the selected node from the root node is

$$( \begin{matrix}n - j \\ i - 1\end{matrix} ) ,$$

and that the total number or paths is 2ⁿ. Each path may produce a unique chain (curve) which comprises

$$1 + \frac{n ( n + 1 )}{2}$$

points. It can also be shown that this set of curves covers the solution space (all the 2ⁿ points) associated with the Subset Sum Problem. Furthermore, the family of curves obtained by paths in the H graph are all non-decreasing paths (i.e., the subset sums along the path are non-decreasing) for every instance of a of size n. Thus, they form a universal structure.

Since each curve may have

$$1 + \frac{n ( n + 1 )}{2}$$

points, by considering each pair of adjacent points there are

$$\frac{n ( n + 1 )}{2}$$

edges. Tnus, each curve may be a set of

$$\frac{n ( n + 1 )}{2}$$

separate edges. Since a τ operation causes a portion of the pᵢ (or the qᵢ) curve to transform into a qⱼ (or a pⱼ) curve respectively, the edges of a given curve project onto the interacting edges of a complementary curve.

At act 305, the subset sum system constructs one or more arc weights. Based on the transformation ∂pᵢ→∂qⱼ, where i>j, the subset sum system may transform a pⱼ portion of the pᵢ curve to a qⱼ curve. From the definition of a τ transform, the first

$$\frac{j ( j + 1 )}{2}$$

edges out of

$$\frac{i ( i + 1 )}{2}$$

edges of the pᵢ curve are mapped to

$$\frac{j ( j + 1 )}{2}$$

edges or qⱼ. The subset sum system may view such a transformation as a mapping of edges. That is, in such embodiments, pᵢ may be treated as a set of

$$\frac{i ( i + 1 )}{2}$$

edges, and the first

$$\frac{j ( j + 1 )}{2}$$

edges may be mapped to the edges of qⱼ. Based on the definition of interacting edges and interaction weights, the subset sum system may form arcs between the edges of pᵢ and qⱼ. This may result in a total of Wⱼ arcs. Thus, a single τⱼ transformation arc leads to Wⱼ translations between the edges. The idea is similar to when the subset sum system uses the transformation ∂qᵢ→∂pⱼ instead.

At act 306, the subset sum system identifies an edge that intersects the orbital line. The subset sum system selects a target number T, and determines the number of subsets, if any, that sum to T. The subset sum system may draw a horizontal line in the Cartesian plane corresponding to y=T—this line may be referred to as an orbital line (OL). Because 0≤T≤Aₙ, and the curve pₙ starts at (0,0) and ends at (Bₙ, Aₙ), the OL intersects pₙ. The subset sum system may locate the intersection point to one unique edge or several edges if at least a portion of the elements of a are identical. The subset sum system may assume that there is one unique edge of pₙ. In a case where multiple edges of pₙ intersect the OL, the subset sum system may determine that the OL goes through (i.e., intersects) one or more of the vertex points of these edges. In such a case, the subset sum system may have identified more than one solution. In some embodiments, the subset sum system refers to such an edge as the root and denotes the edge as e₀. If the intersection point of the curve pₙ with the OL is (xᵢₙₜ, yᵢₙₜ) where yᵢₙₜ=T, the point is between the lower end point

$$( {x}_{0}^{-} , {y}_{0}^{-} )$$

and the higher end point

$$( {x}_{0}^{+} , {y}_{0}^{+} )$$

of the edges because the point lies on the edge. If the origin of the coordinate system were at the lower end point, then the coordinates of the intersection point would be

$$( {x}_{int} - {x}_{0}^{-} , {y}_{int} - {y}_{0}^{-} ) = ( {x}_{0} , {y}_{0} )$$

(i.e., the local coordinates).

At act 307, the subset sum system constructs the search graph based on the transformation graph and arc weights determined in acts 305 and 306. In some embodiments, the subset sum system converts the H graph to a graph where nodes are edges and arcs are translations. The subset sum system may denote this graph as G (the “Search Graph”). Using the standard notation of graphs, V(G) denotes the set of nodes and E(G) denotes the set of arcs of G. The subset sum system may denote the number of nodes as |V(G)| and the number of arcs as |E(G)|. It can be shown that the size of the Search Graph, i.e., the total number of nodes and arcs is less than n⁶.

The Search Graph generated at act 307 is associated with the Subset Sum Problem identified in act 301. Generating a search graph in such a manner is non-obvious and may be used by the subset sum system to perform the methods and processes described herein. In act 306, the subset sum system identifies the edge that intersects the OL. The subset sum system may use the edge e₀∈pₙ as the root node of G. A path in G may be a sequence of edges, such as one from each level where every adjacent pair of edges is connected by an arc. The subset sum system may define T as a path of length l∈[n] in G, with the sequence of nodes (or edges) (e₀, e₁, . . . , eₗ) starting with the root node such that adjacent edges are on adjacent layers and connected by some arc weight. As discussed above, the intersection point of edge e₀ and the OL in local coordinates may be z₀=(x₀, y₀). As a result, the subset sum system may identify the intersection point in edge e₁ along the path π as the path length given by y₁=y₀+w̅_̅{̅0̅,̅1̅}̅ where the overline represents complex conjugation. Similarly, for an edge eⱼ at level j∈[l] from the root node, the subset sum system may identify the intersection point as

$${y}_{j} = {y}_{0} + {Σ}_{l = 1}^{j} \overline{{w}_{l - 1 , l}} .$$

In such an example, for any j∈[l], the path with path length yⱼ is considered by the subset sum system as a valid path if it lies between the lower and upper end points of the edge eⱼ. Otherwise, the subset sum system identifies the path as an invalid path. If yⱼ=0, then the path is identified by the subset sum system as a zero path. A zero path indicates that the curve containing the edge eⱼ intersects the OL at a vertex point, which is a solution to the Subset Sum Problem.

At act 308, the subset sum system iteratively refines and filters the search graph, as discussed above in connection with the process 200.

At act 309, the subset sum system identifies the solution graph, as discussed above in connection with the process 200.

After act 309, the process 300 ends.

FIG. 4 is a circuit diagram of a sample circuit 400 for which the subset sum system 100 is able to be used, according to various embodiments described herein. The circuit 400 includes inputs 401a, 401b, and 401c, one or more negation blocks 403, one or more OR gates 404, and one or more AND gates 405. The circuit 400 may be verified by determining which inputs result in a particular output of the circuit (i.e., “TRUE” or “1”). This determination is an example of the Boolean circuit satisfiability problem. The circuit 400 consists of a finite number of layers of logic gates (NOT, OR and AND), with n Boolean inputs x=(x₁, x₂, x₃) and a single output y, which may be “1” or “0” representing “TRUE” or “FALSE” respectively. Although only three inputs and one output are shown in the sample circuit 400, one of ordinary skill in the art would recognize that the functions of the subset sum system 100 may be performed with respect to circuits that have greater than or less than three inputs and one output. To verify the viability of the circuit 400, the subset sum system determines which values of x₁,x₂, and x₃ result in an output value of “1.” The subset sum system generates a SAT formula for the circuit 400, such as by propagating different inputs through the layers to obtain an expression for “y=f(x).” For the example circuit 400, the generated SAT formula is:

$$y = ( \overline{{x}_{1}} ⋁ \overline{{x}_{2}} ⋁ \overline{{x}_{3}} ) ⋀ ( \overline{{x}_{1}} ⋁ \overline{{x}_{2}} ⋁ {x}_{3} ) ⋀ ( \overline{{x}_{1}} ⋁ {x}_{2} ⋁ {x}_{3} ) ⋀ ( {x}_{1} ⋁ \overline{{x}_{2}} ⋁ \overline{{x}_{3}} ) ⋀ ( {x}_{1} ⋁ \overline{{x}_{2}} ⋁ {x}_{3} ) ( {x}_{1} ⋁ {x}_{2} ⋁ \overline{{x}_{3}} ) ⋀ ( {x}_{1} ⋁ {x}_{2} ⋁ {x}_{3} )$$

In this notation, a horizontal line above a variable indicates a logical negation, “∨” means a logical OR, and “∧” means a logical AND. In this formula there are three input variables and seven clauses each of size 3 (i.e., with three literals).

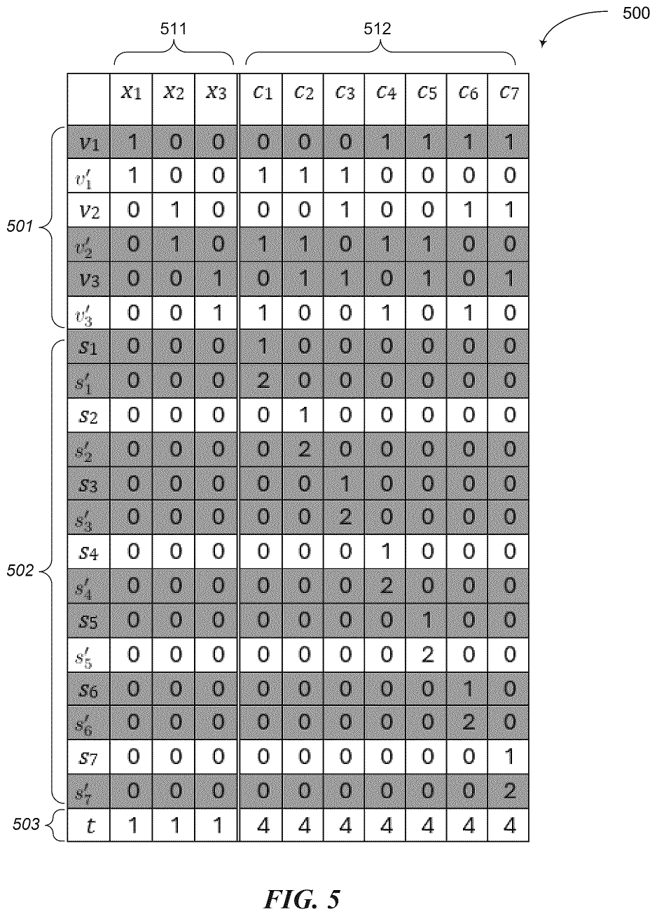

Since each clause has exactly 3 literals, this SAT problem is called a “3SAT problem.” The subset sum system reduces the 3SAT formula, such as by using one or more of the methods discussed in: Sipser, M., “Introduction to The Theory of Computation, Third Edition”, Cengage Learning, 20 Channel Center Street, Boston MA 02210, 2013, and Papadimitriou, C. H., “Computational complexity”, Addison-Wesley, ISBN, 0201530821, 9780201530827, 1994. Sipser, M., “Introduction to The Theory of Computation, Third Edition”, Cengage Learning, 20 Channel Center Street, Boston MA 02210, 2013, and Papadimitriou, C. H., “Computational complexity”, Addison-Wesley, ISBN, 0201530821, 9780201530827, 1994, are incorporated by reference herein. Where any document incorporated by reference conflicts with the present disclosure, the present disclosure controls. In some embodiments, the subset sum system uses the table 500, described below in connection with FIG. 5, to reduce a SAT formula into a SSP.

FIG. 5 is a table diagram of a sample table 500 generated as part of solving a subset sum problem for the sample circuit described above in connection with FIG. 4, according to various embodiments described herein. The conversion process is illustrated in FIG. 5, where the subset sum system identifies several slack variables in addition to the original variables x₁, x₂ and x₃. The seven identified slack variables for the Boolean circuit described above with respect to FIG. 4 are:

$${c}_{1} = ( \overline{{x}_{1}} ⋁ \overline{{x}_{2}} ⋁ \overline{{x}_{3}} )$$

$${c}_{2} = ( \overline{{x}_{1}} ⋁ \overline{{x}_{2}} ⋁ {x}_{3} )$$

$${c}_{3} = ( \overline{{x}_{1}} ⋁ {x}_{2} ⋁ {x}_{3} )$$

$${c}_{4} = ( {x}_{1} ⋁ \overline{{x}_{2}} ⋁ \overline{{x}_{3}} )$$

$${c}_{5} = ( {x}_{1} ⋁ \overline{{x}_{2}} ⋁ {x}_{3} )$$

$${c}_{6} = ( {x}_{1} ⋁ {x}_{2} ⋁ \overline{{x}_{3}} )$$

$${c}_{7} = ( {x}_{1} ⋁ {x}_{2} ⋁ {x}_{3} )$$

With regards to FIG. 5, there are ten columns 511 and 512 where the first three columns 511 correspond to the input variables and the last seven columns 512 correspond to the seven clauses of the Boolean formula associated with the Boolean circuit described above with respect to FIG. 4. For each variable xᵢ, the subset sum system identifies two rows—one where it takes a value of 1 and the second where it takes a value of 0. These rows 501 are labeled vᵢ and vₜ, respectively. In row 1, which corresponds to variable x₁, the subset sum system enters a one in the clause columns that contain the variable; these are clauses four through seven (i.e., c₄ to c₇). Since the first three clauses contain a negation, i.e., x̅₁̅, the subset sum system enters a zero in the corresponding columns. The second row corresponds to the negated variable x̅₁̅, which appears in the first three clauses (i.e., c₁ to c₃). Thus, the subset sum system enters a one in the columns corresponding to clauses one through three, and a zero in the rest of the columns. Similarly, for each clause cⱼ, the subset sum system identifies we have two rows sⱼ and s̅ⱼ̅ which contain a 1 and a 2 respectively in the column corresponding to the clause. These are slack variables to ensure that each column sum is less than or equal to 6, and are the rows 502. In this table, because there are three literals in each clause associated with the Boolean circuit 400, the numbers entered in the rows 501 and 502 of the table 500 (i.e., rows that do not indicate the target number) may be any number between, and inclusive of, 0 and 3. The numbers entered in rows 501 and 502 of the table 500 represent the number of literals that evaluate to “TRUE” in the clause based on the slack variables and input variables. The last row 503 in the table corresponds to the target number which consists of ones in the variable columns and fours in the clause columns. Each row is considered as a decimal number and the subset sum system may ignore leading zeros. In some embodiments, the subset sum system identifies a satisfying assignment to the 3SAT formula (i.e., at least one solution is identified by the subset sum system) if and only if there is a subset of the rows which, when added together as numbers, equals the target row. In FIG. 5, the highlighted rows 1, 4, 5, 7, 8, 10, 11, 12, 14, 15, 17, 18 and 20 added together result in the target number 1114444444. These rows are selected by the subset sum system because they are the only rows that will result in the target number when the values in the columns are added together as numbers. Thus, there are 21 rows and 10 columns in the table 500.

The SSP corresponding to the table 500 is:

$$a = ( 1001110000 , 1000001111 , 101101100 , 100010011 , 11001010 , 10110101 , 2000000 , 1000000 , 200000 , 100000 , 20000 , 10000 , 2000 , 1000 , 200 , 20 , 10 , 2 , 1 ) and T = 1.114444444 \times {10}^{9}$$

The solution to this SSP is found using the processes 200 and 300 described above in connection with FIGS. 2 and 3. The solution vector is x=(1,0,0,1,1,0, | |1,1,0,1,1,1,0,1,1,0,1,1,0,1) where a 1 indicates that the row (counted from left) is included in the solution. Furthermore, in some embodiments, the subset sum system only considers the values to the left of ∥ (i.e., the values in the columns 511), since the values to the right (i.e., the values in the columns 512) correspond to the slack variables corresponding to the clauses. In some embodiments, the subset sum system may only consider the highlighted rows. Thus, x₁=1, x₂=0, and x₃=1 is the solution to the Boolean Circuit Satisfiability Problem described above in connection with the sample circuit 400. One of ordinary skill in the art can verify that this solution satisfies all the seven clauses of the 3SAT formula.

Although this method applies to an arbitrary number of literals and clauses, this small example is only for the purpose of illustrating the processes performed by the subset sum system, and the methods described above may be used for any number of literals and clauses.

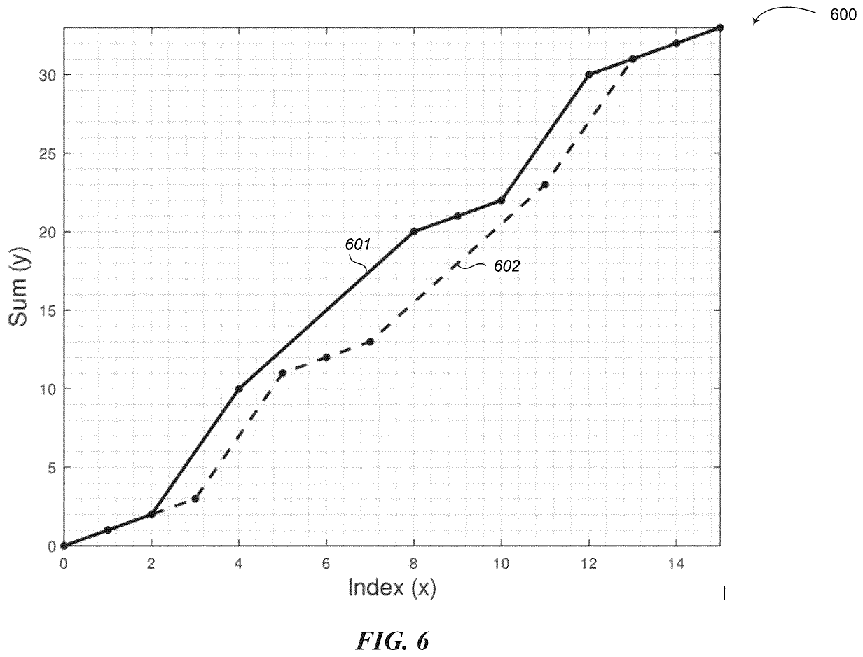

FIG. 6 is a graph diagram of a first curve 600 generated as part of solving the subset sum problem for the sample circuit described above in connection with FIG. 4, according to various embodiments described herein. The graph diagram of the first curve 600 includes the p₄ curve 601 and q₄ curve 602 for the SSP associated with the Boolean circuit 400 described above in connection with FIG. 4. Each curve consists of linear segments called edges (or translated links). An edge on p₄ can overlap (interact) with one or more edges on q₄ in the y coordinate, and vice versa. The p₄ curve 601 and q₄ curve 602 represent curves generated for the SSP associated with the Boolean circuit 400 when n=4. The p₄ curve 601 and q₄ curve 602 may be generated by the subset sum system based on one or more of the chains determined above as part of performing the process 300, such as the elemental chains, complementary chains, etc.

FIG. 7 is a graph diagram of a second curve 700 generated as part of solving the subset sum problem for the sample circuit described above in connection with FIG. 4, according to various embodiments described herein. The graph diagram of the second curve 700 includes the p₈ curve 701 and q₈ curve 702 for the SSP associated with the Boolean circuit described above in connection with FIG. 4. Each curve consists of linear segments called edges (or translated links). An edge on p₈ can overlap (interact) with one or more edges on q₈ in the y coordinate, and vice versa. The p₈ curve 701 and q₈ curve 702 represent curves generated for the SSP associated with the Boolean circuit 400 when n=8. The p₈ curve 701 and q₈ curve 702 may be generated by the subset sum system based on one or more of the chains determined above as part of performing the process 300, such as the elemental chains, complementary chains, etc.

FIG. 8 is a graph diagram of a third curve 800 generated as part of solving the subset sum problem for the sample circuit described above in connection with FIG. 4, according to various embodiments described herein. The graph diagram for the third curve 800 includes the p₁₆ curve 801 and q₁₆ curve 802 for the SSP associated with the Boolean circuit described above in connection with FIG. 4. Each curve consists of linear segments called edges (or translated links). An edge on p₁₆ can overlap (interact) with one or more edges on q₁₆ in the y coordinate, and vice versa. The p₁₆ curve 801 and q₁₆ curve 802 represent curves generated for the SSP associated with the Boolean circuit 400 when n=16. The p₁₆ curve 801 and q₁₆ curve 802 may be generated by the subset sum system based on one or more of the chains determined above as part of performing the process 300, such as the elemental chains, complementary chains, etc.

FIG. 9 is a graph diagram of a fourth curve 900 generated as part of solving the subset sum problem for the sample circuit described above in connection with FIG. 4, according to various embodiments described herein. The fourth curve 900 includes the p₂₀ curve 901 and q₂₀ curve 902 for the SSP associated with the Boolean circuit described above in connection with FIG. 4. Each curve consists of linear segments called edges (or translated links). An edge on p₂₀ can overlap (interact) with one or more edges on q₂₀ in the y coordinate, and vice versa. The p₂₀ curve 901 and q₂₀ curve 902 represent curves generated for the SSP associated with the Boolean circuit 400 when n=20. The p₂₀ curve 901 and q₂₀ curve 902 may be generated by the subset sum system based on one or more of the chains determined above as part of performing the process 300, such as the elemental chains, complementary chains, etc. The curves 600, 700, 800, and 900 are presented here to provide a visual representation of curves generated implicitly by the subset sum system. Accordingly, in some embodiments, the subset sum system does not generate a visual representation of one or more of the curves 600, 700, 800, and 900.

FIG. 10 is a block diagram of a sample transformation graph 1000 generated as part of solving the subset sum problem for the sample circuit described above in connection with FIG. 4, according to various embodiments described herein. The transformation graph 1000 includes the paths generated from the starting curve p₆ by repeated τ transforms. In the sample transformation graph 1000, only the active regions of the paths are shown at each level. The size of the active region decreases monotonically with depth. This directed acyclic graph structure has a root node 1001 and 7 levels: the first level 1011, the second level 1012, the third level 1013, the fourth level 1014, the fifth level 1015, and the sixth level 1016.

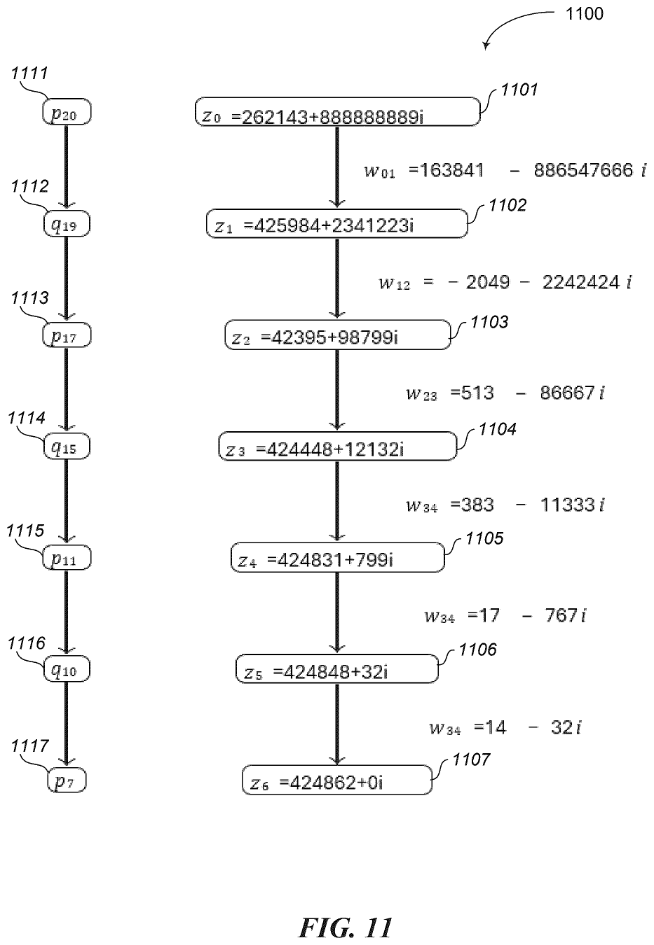

FIG. 11 is a diagram of a sample solution graph 1100 generated as part of solving the subset sum problem for the sample circuit described above in connection with FIG. 4, according to various embodiments described herein. On the left the path in the Transformation Graph is shown, and on the right the local values of the path in the Search Graph are shown. Each of the reference numerals 1111-1117 indicates a point on the path of the transformation graph. Likewise, each of the reference numerals 1101-1107 indicates a value of the path in the search graph. A solution for the SSP associated with the sample circuit lies on a curve p₇ resulting from 6 transformations of the initial curve p₂₀.

The Solution Graph may be a path in the Transformation Graph and a path in the Search Graph. On the right side, the local coordinates of the intersection points are shown. The final value has an imaginary part equal to zero, which means that the edge intersecting the orbital line intersects it at a vertex point. The binary representation of the x-coordinate (after adjusting for the sorting performed by the subset sum system in the processes 200 and 300), i.e., 424862, indicates the solution. For the sample Boolean circuit problem described above in connection with FIG. 4, the solution turns out to be x₁=1, x₂=0, x₃=1. Thus, the given circuit is satisfiable. If for another example, the solution graph is empty, then it means that the circuit is not satisfiable. In such cases, the subset sum system may remove one or more constraints in the original problem and perform the processes 200 and 300 to determine whether the resulting circuit is satisfiable.

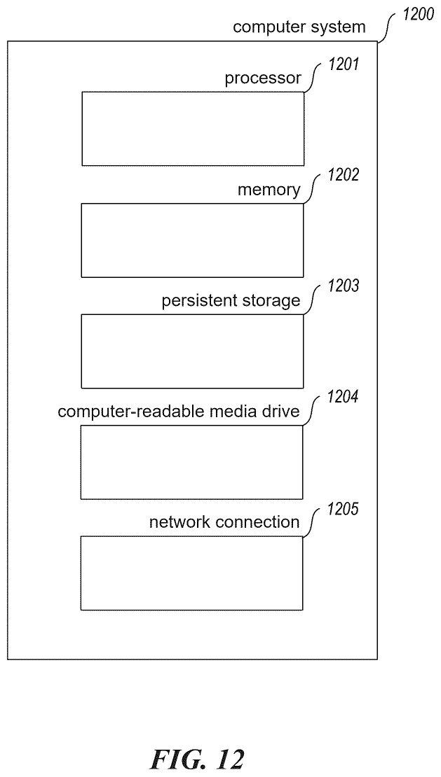

FIG. 12 is a block diagram showing some of the components typically incorporated in at least some of the computer systems and other devices on which embodiments of the systems and methods described herein may operate. In various embodiments, these computer systems and other devices 1200 can include server computer systems, cloud computing platforms or virtual machines in other configurations, desktop computer systems, laptop computer systems, netbooks, mobile phones, personal digital assistants, televisions, cameras, automobile computers, electronic media players, etc. In various embodiments, the computer systems and devices include zero or more of each of the following: a processor 1201 for executing computer programs and/or training or applying machine learning models, such as a CPU, GPU, TPU, NNP, FPGA, or ASIC; a computer memory 1202—such as RAM, SDRAM, ROM, PROM, etc.—for storing programs and data while they are being used, including the system and associated data, an operating system including a kernel, and device drivers; a persistent storage device 1203, such as a hard drive or flash drive for persistently storing programs and data; a computer-readable media drive 1204, such as a floppy, CD-ROM, or DVD drive, for reading programs and data stored on a computer-readable medium; and a network connection 1205 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. None of the components shown in FIG. 1 and discussed above constitutes a data signal per se. While computer systems configured as described above are typically used to support the operation of the system, those skilled in the art will appreciate that the system may be implemented using devices of various types and configurations, and having various components.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system comprising:
at least one processor; and
at least one memory coupled to the at least one processor, the memory having computer-executable instructions stored thereon that, when executed by the at least one processor, cause the system to:
receive an indication of a circuit, the circuit having three or more inputs, one or more outputs, and two or more logic gates;
generate a logical representation of the circuit based on the three or more inputs, one or more outputs, and two or more logic gates, the logical representation including one or more literals, each literal indicating an input to the circuit, and one or more clauses, each clause indicating a logical OR of two or more literals;
identify a target number and a sequence of one or more numbers based on the three or more inputs and the one or more clauses;
generate a search graph based on the target number and the sequence of one or more numbers;
based on the generated search graph, generate an indication of one or more values for the one or more literals that, when subjected to the circuit, cause the circuit to output 1, wherein to generate the indication of one or more values for the one or more literals the system:
determines, based on the generated search graph, whether at least one zero path is indicated by the search graph;
based on a determination that at least one zero path is indicated by the search graph, generates a solution graph based on the search graph and the at least one zero path, the solution graph indicating the one or more values for the one or more literals; and
based on a determination that at least one zero path is not indicated by the search graph, generates an indication of a second circuit which has at least one fewer inputs, at least one fewer outputs, or at least one fewer logic gates than the received circuit, and generates a second search graph to identify one or more values that cause the second circuit to output 1; and
verify the functionality of the circuit based on the indication of one or more values for the one or more literals.

2. (canceled)

3. The system of claim 1, wherein the solution graph indicates one or more classifications for the one or more values, and wherein the computer-executable instructions, further cause the system to:
select at least one of the one or more values based on the one or more classifications for the one or more values.

4. The system of claim 1, wherein, based on a determination that no zero path is indicated by the search graph, the computer-executable instructions further cause the system to:
receive input indicating a change for an aspect of the logical representation of the circuit;
change the aspect of the logical representation of the circuit based on the received input, the changed aspect corresponding to a potential change to at least one input, at least one output, or at least one logic gate of the circuit;
generate a second search graph based on the target number and a second sequence of the one or more numbers identified based on the changed at least one input, at least one output, or at least one logic gate of the circuit;
determine, based on the generated search graph, whether at least one zero path is indicated by the search graph; and
based on a determination that at least one zero path is indicated by the search graph, generate a solution graph based on the search graph and the at least one zero path, the solution graph indicating the one or more values for the one or more literals.

5. The system of claim 1, wherein, to generate the solution graph, the computer-executable instructions further cause the system to:
identify one or more edges of the search graph; and
refine the search graph by dividing each of the one or more edges of the search graph into two or more divided edges of the search graph.

6. The system of claim 1, wherein, to generate the solution graph, the computer-executable instructions further cause the system to:
identify one or more nodes of the search graph that do not resolve into a zero path; and
filter the search graph by removing each of the identified one or more nodes.

7. The system of claim 1, wherein, to generate the solution graph, the computer-executable instructions further cause the system to:
identify one or more arcs of the search graph that do not resolve into a zero path; and
filter the search graph by removing each of the identified one or more arcs.

8. The system of claim 1, wherein, to generate the search graph, the computer-executable instructions further cause the system to:
construct a sequence of complex numbers from a sequence of positive integers;
construct a representation of a set of line segments that act as nodes in the search graph;
construct a set of complex arc weights from the set of line segments, the arc weights each connecting two or more nodes in the search graph; and
identify an initial value from the target number and determination of a root node in the search graph containing the initial value.

9. The system of claim 1, wherein, to generate the indication of one or more values for the one or more literals, the computer-executable instructions further cause the system to:
generate a solution graph by iteratively modifying the search graph via one or more refining operations or one or more filtering operations; and
identify the one or more values for the one or more literals based on the solution graph.

10. A non-transitory processor-readable storage medium that stores at least one of instructions or data, the instructions or data, when executed by at least one processor, cause the at least one processor to:
receive an indication of a technological problem;
generate a representation of the technological problem as a Boolean circuit, the Boolean circuit receiving three or more inputs, outputting one or more outputs, and performing two or more manipulations of the one or more inputs to arrive at the one or more outputs;
generate a logical representation of the Boolean circuit based on the three or more inputs, one or more outputs, and two or more manipulations, the logical representation including one or more literals, each literal indicating an input to the circuit, one or more clauses, each clause indicating a logical OR of two or more literals;
identify a target number and a sequence of one or more numbers based on the three or more inputs and the one or more clauses;
generate a search graph based on the target number and the sequence of one or more numbers;
based on the generated search graph, generate an indication of one or more values for the one or more literals that, when subjected to the Boolean circuit, cause the Boolean circuit to output 1, wherein to generate the indication of one or more values for the one or more literals, the at least one processor is caused to:
determine, based on the generated search graph, whether at least one zero path is indicated by the search graph; and
based on a determination that at least one zero path is indicated by the search graph, generate a solution graph based on the search graph and the at least one zero path, the solution graph indicating the one or more values for the one or more literals; and
generate a solution to the technological problem based on the indication of the one or more values for the one or more literals that, when subjected to the Boolean circuit, case the Boolean circuit to output 1.

11. (canceled)

12. The non-transitory processor-readable storage medium of claim 10, wherein the solution graph indicates one or more classifications for the one or more values, and wherein the processor is further caused to:
select at least one of the one or more values based on the one or more classifications for the one or more values.

13. The non-transitory processor-readable storage medium of claim 10, wherein, based on a determination that no zero path is indicated by the search graph, the processor is further caused to:
receive input indicating a change for an aspect of the logical representation of the circuit;
change the aspect of the logical representation of the Boolean circuit, the changed aspect corresponding to a potential change to at least one input, at least one output, or at least one manipulation;
generate a second search graph based on the target number and a second sequence of the one or more numbers identified based on the changed at least one input, at least one output, or at least one manipulation;
determine, based on the generated search graph, whether at least one zero path is indicated by the search graph; and
based on a determination that at least one zero path is indicated by the search graph, generate a solution graph based on the search graph and the at least one zero path, the solution graph indicating the one or more values for the one or more literals.

14. The non-transitory processor-readable storage medium of claim 10, wherein, to generate the solution graph, the processor is further caused to:
identify one or more edges of the search graph; and
refine the search graph by dividing each of the one or more edges of the search graph into two or more divided edges of the search graph.

15. The non-transitory processor-readable storage medium of claim 10, wherein, to generate the solution graph, the processor is further caused to:
identify one or more nodes of the search graph that do not resolve into a zero path; and
filter the search graph by removing each of the identified one or more nodes.

16. The non-transitory processor-readable storage medium of claim 10 wherein, to generate the solution graph, the processor is further caused to:
identify one or more arcs of the search graph that do not resolve into a zero path; and
filter the search graph by removing each of the identified one or more arcs.

17. A method comprising:
receiving an indication of a circuit, the circuit having three or more inputs, one or more outputs, and two or more logic gates;
generating a logical representation of the circuit based on the three or more inputs, one or more outputs, and two or more logic gates, the logical representation including one or more literals, each literal indicating an input to the circuit, and one or more clauses, each clause indicating a logical OR of two or more literals;
identifying a target number and a sequence of one or more numbers based on the three or more inputs and the one or more clauses;
generating a search graph based on the target number and the sequence of one or more numbers;
based on the generated search graph, generating an indication of one or more values for the one or more literals that, when subjected to the circuit, cause the circuit to output 1 by:
determining, based on the generated search graph, whether at least one zero path is indicated by the search graph; and
based on a determination that at least one zero path is indicated by the search graph, generating a solution graph based on the search graph and the at least one zero path, the solution graph indicating the one or more values for the one or more literals; and
verifying the functionality of the circuit based on the indication of one or more values for the one or more literals.

18. (canceled)

19. The method of claim 17, wherein the solution graph indicates one or more classifications for the one or more values, and wherein the method further comprises:
selecting at least one of the one or more values based on the one or more classifications for the one or more values.

20. The method of claim 17, wherein, based on a determination that no zero path is indicated by the search graph, the method further comprises:
receiving input indicating a change for an aspect of the logical representation of the circuit;
changing the aspect of the logical representation of the circuit, the changed aspect corresponding to a potential change to at least one input, at least one output, or at least one logic gate of the circuit;
generating a second search graph based on the target number and a second sequence of the one or more numbers identified based on the changed at least one input, at least one output, or at least one logic gate of the circuit;
determining, based on the generated search graph, whether at least one zero path is indicated by the search graph; and
based on a determination that at least one zero path is indicated by the search graph, generating a solution graph based on the search graph and the at least one zero path, the solution graph indicating the one or more values for the one or more literals.

21. The method of claim 17, wherein generating the solution graph comprises:
identifying one or more edges of the search graph; and
refining the search graph by dividing each of the one or more edges of the search graph into two or more divided edges of the search graph.

22. The method of claim 17, wherein generating the solution graph comprises:
identify one or more nodes or one or more arcs of the search graph that do not resolve into a zero path; and
filter the search graph by removing each of the identified one or more nodes or one or more arcs.
